(19) United States
(12) Patent Application Publication
(10) Pub. No.: US 2003/0035016 A1
(43) Pub. Date: Feb. 20, 2003

(54) Peripheral equipment and printer where identification information is automatically created

(75) Inventor: Shinji Tanaka, Nagano-ken (JP)

Correspondence Address: SUGHRUE MION, PLLC, 2100 Pennsylvania Avenue, NW, Washington, DC, 20037-3213, US

(73) Assignee: SEIKO EPSON CORPORATION

(21) Appl. No.: 10/206,389

(22) Filed: Jul. 26, 2002

(30) Foreign Application Priority Data
Jul. 27, 2001 (JP) 2001-227342

(51) Int. Cl. B41J 29/393

(52) U.S. Cl. 347/19

(57) ABSTRACT

It is to provide a technique for changing the identification information of the peripheral equipment depending on a device connected to the equipment. A printing controller 61 of a printer comprises a self-identification information storing unit 74 for storing the ID of the printer itself and a memory element input/output controlling unit 73 for obtaining the cartridge ID from a memory element of an ink cartridge. The identification information creating unit 72 creates the machine ID of the printer by combination of the ID of the printer itself and the cartridge ID.

### BACKGROUND OF THE INVENTION

The present invention relates to peripheral equipment of a computer, and more particularly to peripheral equipment which automatically determines its own identification information for itself.

Generally, identification information for identifying the type of the product is attached to an electric equipment including the peripheral equipment of a computer. This identification information can identify the category of the product (printer, scanner, and external storage etc.) and the type within the same category.

Recently, such a technique that a computer automatically installs driver software suitable for each product by using the identification information is in practical use. For example, the Plug-and-Play installed in the Windows (trademark of Microsoft Corporation) that is the operating system of Microsoft Corporation is the typical one.

For example, in case of inkjet printer, when a user changes the type of ink, the user may want to change a printer driver operating on a computer to the most suitable one in some cases. In case of the other peripheral equipment, when a user installs an optional function, there are cases where the user wants to update the driver software.

In many cases, identification information is uniquely assigned to each product such as peripheral equipment in a distinctive way within the category of the products. The identification information remains unchanged during the period from manufacture of the product to its abandonment. Namely, even if an additional function is attached to the product, or even if the product is used in connection with the other device, the identification information of the product will never change.

As a result, even if a user wants to update the driver software as mentioned above, the driver software cannot be automatically updated, according to the conventional automatic install technique of the driver software. Namely, a user has to install or switch it manually.

An object of the present invention is to provide a technique for changing the identification information of the peripheral equipment depending on a device to be connected with the equipment.

### SUMMARY OF THE INVENTION

In order to achieve the above object, the peripheral equipment according to the present invention has the following structure. Namely, it comprises a memory for storing the identification information of the peripheral equipment itself, a connector for connecting a device, an obtaining unit for obtaining the identification information of a device from the device connected to the connector, an identification information deciding unit for deciding the identification information of the peripheral equipment based on the identification information of the peripheral equipment itself stored in the memory and the identification information of the device obtained by the obtaining unit, and an output unit for supplying the identification information of the peripheral equipment decided by the identification information deciding unit to a computer.

### BRIEF DESCRIPTION OF THE DRAWINGS

FIG. 1 is a view showing the hardware structure of a print system according to an embodiment of the present invention.

FIG. 2 is an explanatory drawing describing the external appearance of an ink cartridge having a memory element which can be attached to a printer.

FIG. 3 is an explanatory drawing describing the structure of functions of the print system according to the present embodiment.

FIG. 4A is a table of installable drivers and FIG. 4B is a table of already-installed drivers.

FIG. 5 is a flow chart showing the procedure of automatic update of a driver performed at activation of a host or the like.

FIG. 6 is a flow chart showing the procedure when exchanging the ink cartridges of a printer.

### DETAILED DESCRIPTION OF THE PREFERRED EMBODIMENT

Hereinafter, a preferred embodiment of the present invention will be described according to the drawings.

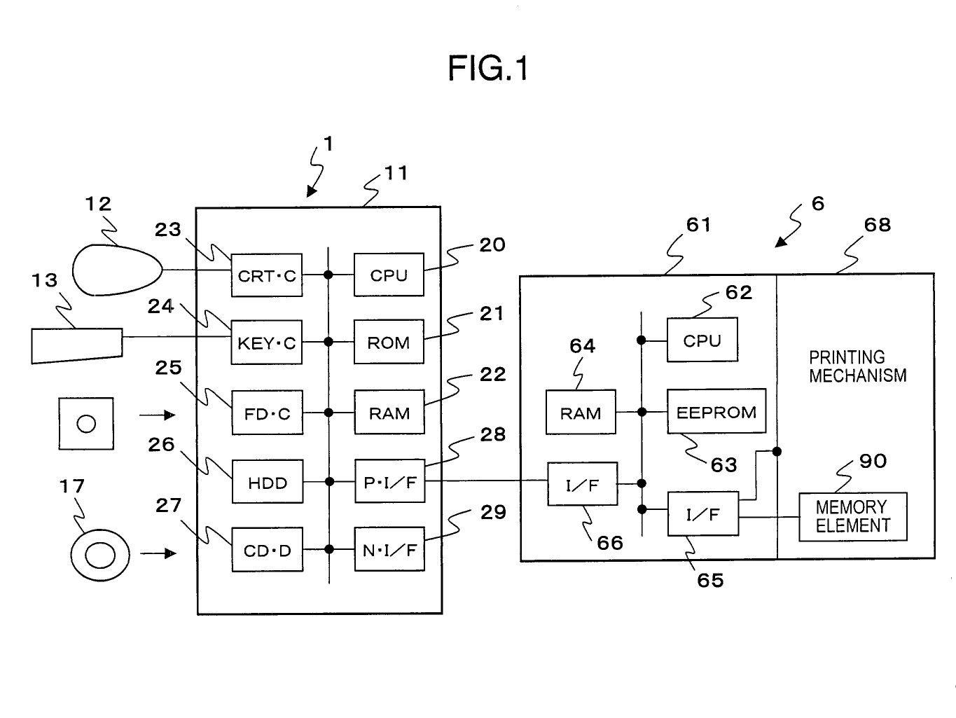

As shown in FIG. 1, a print system of the present embodiment comprises a host computer (hereinafter, referred to as a host) 1 and a printer 6 for printing print data supplied from the host 1.

The host 1 includes a host main unit 11, a display 12, and a keyboard 13. The host main unit 11 includes a CPU 20 for executing various programs or the like, a ROM 21 in which various data and various programs are stored, a RAM 22 in which various data and various programs are temporarily stored, a display controller 23 for controlling the display 12, a keyboard controller 24 for controlling the keyboard 13, a flexible disk drive 25, a hard disk drive 26, a CD-ROM drive 27, a printer interface 28, and a net interface 29.

The printer 6 is, for example, an inkjet printer capable of color printing. When receiving the printing data from the host 1, the printer 6 executes the predetermined printing process to form images on the printing paper that is a printing medium. This printer 6 includes a printing mechanism 68 for actual printing and a printing controller 61 for controlling the above. The printing controller 61 includes a CPU 62 for executing various programs or the like, an EEPROM 63 for storing various data and various programs, a RAM 64 in which various data and various programs are temporarily stored, and interfaces 65 and 66 for exchanging data between the host 1 or the printing mechanism 68. The printing mechanism 68 has a memory element 90. The memory element 90 can be realized by attaching it to the case, removable from the printing mechanism 68, which accommodates an image-forming medium such as ink or toner. As the memory element 90, a semiconductor memory such as IC (Integrated Circuit) is preferably used.

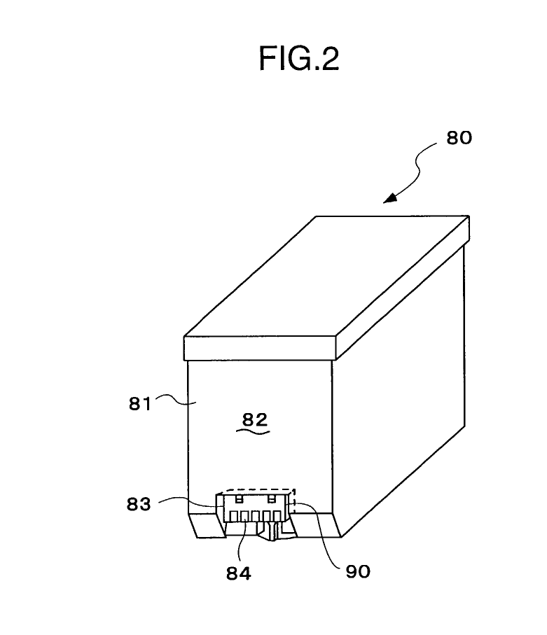

An example of the case which accommodates the image-forming medium, with the memory element 90 attached thereto, will be described by using FIG. 2.

FIG. 2 shows the external appearance of the ink cartridge 80 with the memory element 90 attached thereto. The ink cartridge 80 comprises the main cartridge body 81 having an ink-accommodating portion for accommodating ink, and the memory element 90 built in the side portion 82 of the main cartridge body 81. When the ink cartridge 80 is attached to a cartridge attaching portion, not illustrated, of the printer 6, the memory element 90 is connected to the interface 66 of the printing controller 61 so as to exchange various data between the printer and itself. The memory element 90 is installed in the concave portion 83 exposing a plurality of connection terminals 84. Here, the concave portion 83 is at the side portion 82 of the ink cartridge 80 and its lower part is open. Although a description about the ink cartridge is made here, a toner cartridge that has a toner-accommodating portion for accommodating toner may be used, instead of the ink cartridge.

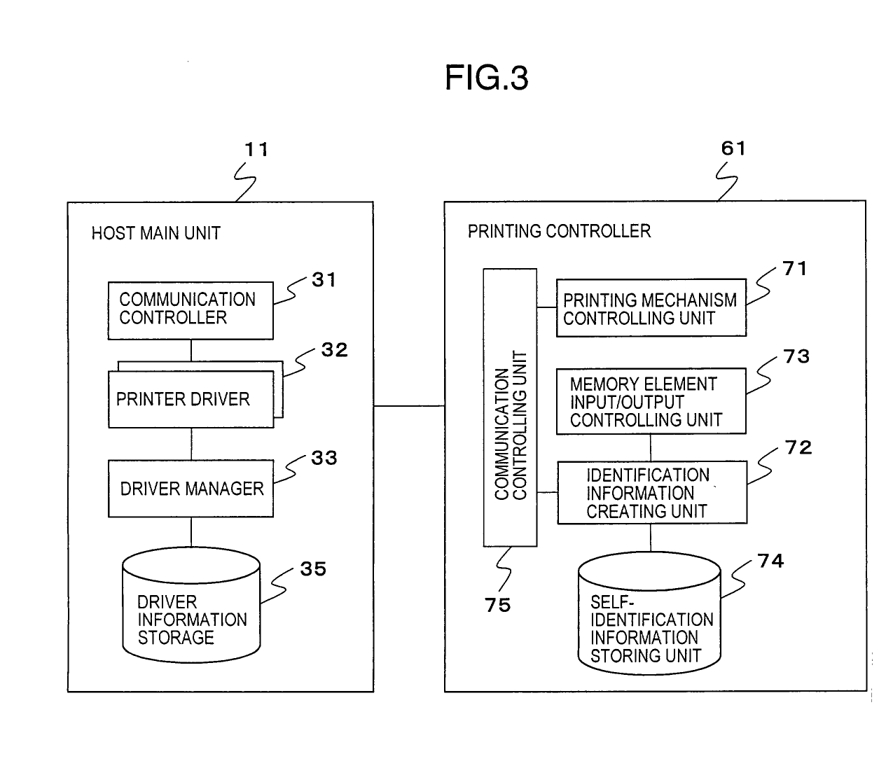

FIG. 3 is a block diagram of functions for describing the internal functions of the host main unit 11 and the printing controller 61. The functions of the host main unit 11 described below are realized by the CPU 20 reading and executing a predetermined program stored in the ROM 21 and the HDD 26. Similarly, the functions of the printing controller 61 are realized by the CPU 62 reading and executing a predetermined program stored in the EEPROM 63.

The printing controller 61 includes a printing mechanism controlling unit 71, an identification information creating unit 72, a memory element input/output controlling unit 73, a self-identification information storing unit 74, and a communication controlling unit 75.

The printing mechanism controlling unit 71 controls the printing mechanism 68 for executing printing.

The memory element input/output controlling unit 73 controls input/output of the memory element 90 installed in the ink cartridge 80 attached to the cartridge attaching portion (not illustrated) of the printer 6. For example, the memory element input/output controlling unit 73 reads out the cartridge ID (identification information) indicating the type of the ink cartridge 80 stored in the memory element 90. Alternatively, the memory element input/output controlling unit 73 may contain a memory, not illustrated, so as to store the read out cartridge ID. The memory element input/output controlling unit 73 reads out the cartridge ID periodically and makes a comparison between the read out cartridge ID and the cartridge ID stored in the memory not illustrated. Thus, the memory element input/output controlling unit 73 can detect an exchange of the ink cartridges. Reading out of the cartridge ID is performed at a time of receiving a printing request from the host 1, or before executing printing. Thus, printing can be performed always by the optimum printer driver, also together with the processing described later.

The self-identification information storing unit 74 stores the self-ID (identification information) for identifying the printer itself. The printer itself here indicates the structure for realizing the basic function of a printer, excluding ink cartridges. More concretely, it includes the printing controller 61 and the printing mechanism 68 and excludes the ink cartridge. Further, it excludes a device for an optional function such as accelerator board.

The identification information creating unit 72 decides the machine ID of the printer, according to the self-ID of the printer and the cartridge ID. More specifically, the identification information creating unit 72 obtains the self-ID from the self-identification information storing unit 74 and obtains the cartridge ID from the memory element input/output controlling unit 73. Then, the identification information creating unit 72 decides the machine ID of the printer in combination of these. For example, when the self-ID is “PR-100” and the cartridge ID is “typeA”, the machine ID may be defined as “PR-100A”. Thus, the machine ID of the printer is uniquely decided not only by the ID of the printer itself, but by combination of the ID of the printer itself and the cartridge ID. Although the machine ID is decided by using the self-ID and the cartridge ID, the way of deciding the machine ID is not restricted to this. For example, when the printer is connected with the other device for an optional function, it is possible to decide the machine ID further by using the identification information of this device. Thus, the machine ID of the printer can be uniquely decided according to the optional function installed in the printer as well as according to the ID of the printer itself. Accordingly, the machine ID differs between a printer having an optional function and a printer not having an optional function, and the machine ID differs between the printers having different optional functions.

The communication controlling unit 75 supplies and receives the information to and from the outside of the printer 6. For example, the machine ID decided by the identification information creating unit 72 is supplied to the host 1.

The host main unit 11 includes a communication controller 31, a printer driver 32, a driver manager 33, and a driver information storage 35.

The communication controller 31 controls the communication with the outside of the host 1. For example, it controls the communication with the other device connected to the printer 6.

The printer driver 32 controls the printer. The printer driver 32 may be realized by installing a program for the printer driver into the host 1. Since the printer driver 32 may differ depending on the machine type of each printer, a plurality of printer drivers 32 can be provided in the embodiment.

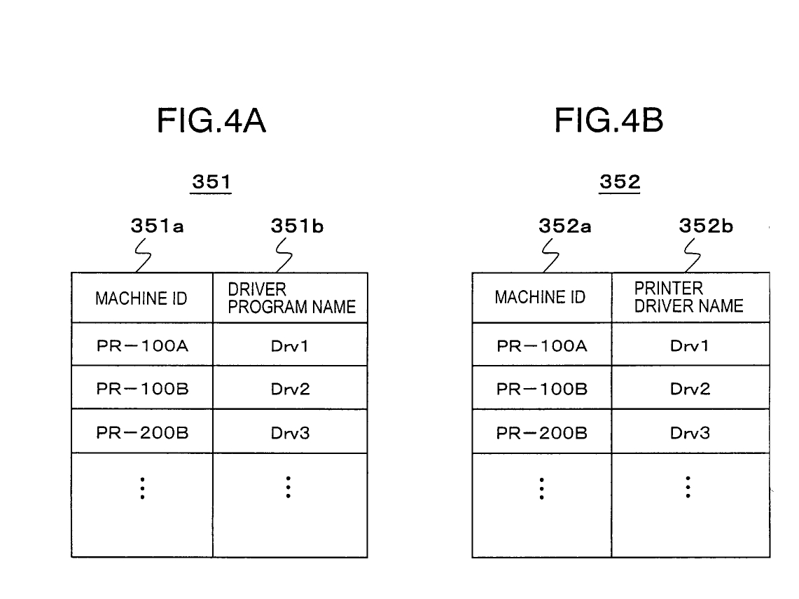

The driver information storage 35 stores the information about an installable driver program and the information about an already-installed printer driver. For example, the driver information storage 35 includes an installable driver table 351 indicated in FIG. 4A and an already-installed driver table 352 indicated in FIG. 4B. In the installable driver table 351, each set of the machine ID 351a and the driver program name 351b is correlated and stored. In the already-installed driver table 352, the machine ID 352a of a printer having a printer driver already installed and the printer driver name 352b are stored.

The driver manager 33 obtains the machine ID of a printer, and installs a program for a printer driver corresponding to the same machine ID, with reference to the installable driver table 351 of the driver information storage 35. When a plurality of printer drivers have been installed, referring to the already-installed driver table 352 of the driver information storage 35, a printer driver corresponding to the machine ID notified from the printer 6 is selected so as to operate. Further, upon receipt of the notice of the machine ID from the printer 6, referring to the installable driver table 351 of the driver information storage 35, the driver manager 33 can install the printer driver 32 corresponding to this machine ID when it has not been installed yet. At this time, a program for the printer driver is obtained from the HDD 26 of the host main unit 11 or the outside of the host 1 (CD-ROM or a server connected with a network).

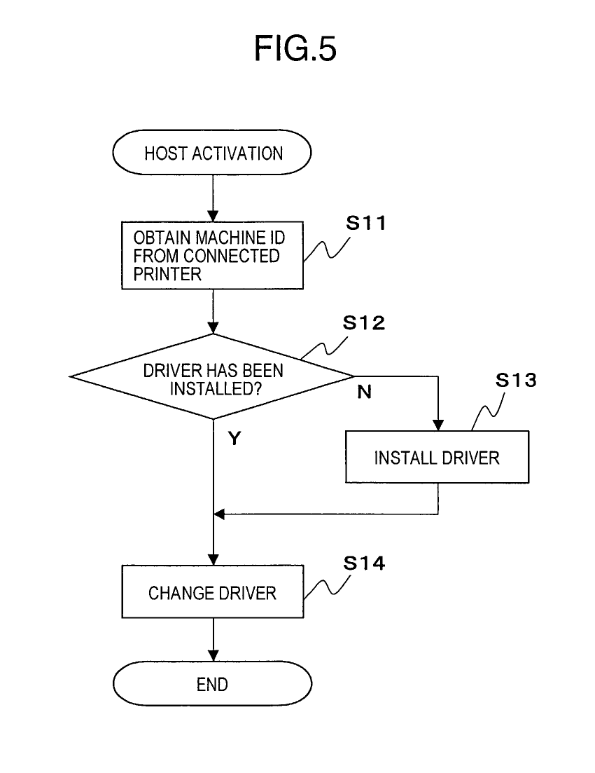

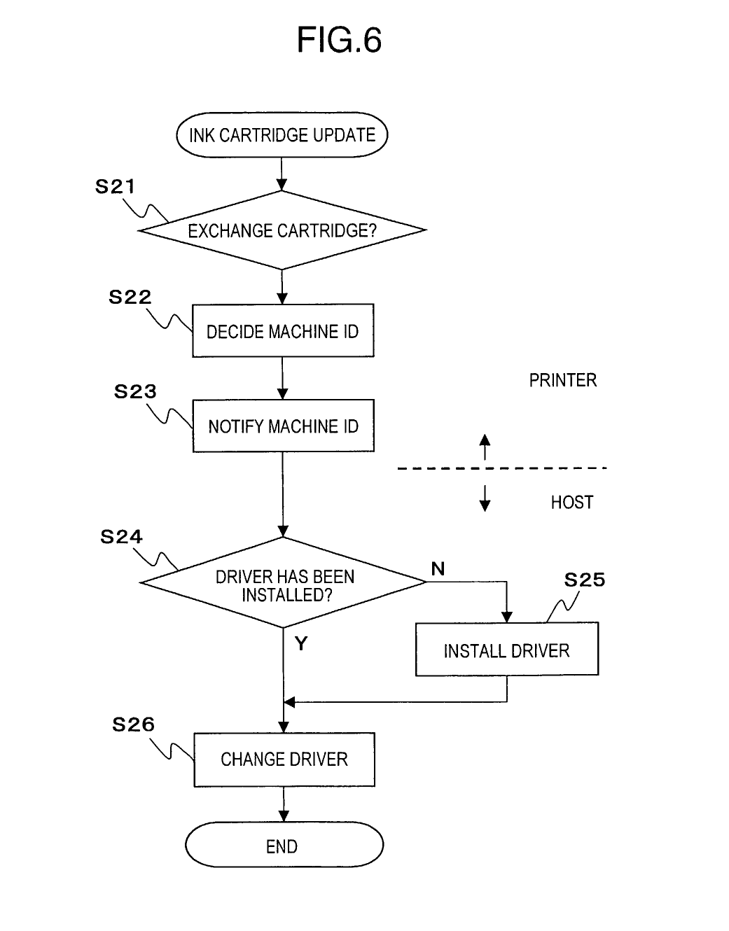

The procedure of the embodiment will be described by using FIGS. 5 and 6.

FIG. 5 is a flow chart showing the procedure of the automatic update of a driver performed at activation of the host 1 or the like. At first, the driver manager 33 obtains the machine ID of the printer from the printer 6 through the communication controller 31 (S11). The driver manager 33 confirms whether the printer driver corresponding to the machine ID has been installed or not, referring to the driver information storage 35 (S12). When it has not been installed yet, the driver manager 33 installs the printer driver (S13). When it has been already installed or its installation has been completed, the driver manager 33 selects the driver corresponding to the machine ID and changes a driver to the above one (S14).

FIG. 6 is a flow chart showing the procedure when the ink cartridge of the printer is exchanged. The memory element input/output controlling unit 73 of the printer 6 monitors whether the ink cartridge is exchanged according to the above procedure (S21). When detecting the exchange of the ink cartridge, the identification information creating unit 72 decides the machine ID, according to the cartridge ID of the ink cartridge installed into the printer and the self-ID of the self-identification information storing unit 74 (S22). The communication controlling unit 75 notifies the host main body 11 of this machine ID.

In the host, the driver manager 33 confirms whether the printer driver corresponding to the machine ID has been already installed, referring to the driver information storage 35 (S24). When it has not been installed yet, the driver manager 33 installs the printer driver (S25). When it has been installed or its installation has been completed, the driver manager 33 selects the driver corresponding to the machine ID and changes a driver to the above one (S26).

According to the above, every time of exchanging the ink cartridges attached to the printer, the printer driver 32 of the host is automatically updated.

Although a description has been made in the above embodiment, taking a printer as an example, the invention is not restricted to this. For example, the invention is applicable to the peripheral equipment of a computer other than a printer. In this case, a device for realizing a basic function of the peripheral equipment is regarded as the peripheral equipment main unit. Then, the identification information of such a device so as to add a function to the peripheral equipment, which is used in connection with the peripheral equipment main unit, is combined with the identification information of the peripheral equipment main unit, hence to define it as the identification information of the peripheral equipment.

Although, in the above embodiment, a description has been made in case of automatically updating a driver, the invention is not restricted to this. For example, besides a driver, an electronic manual may be automatically installed.

What is claimed is:

1. Peripheral equipment of a computer comprising:
a memory for storing identification information of the peripheral equipment itself;
a connector portion for connecting a device;
an obtaining unit for obtaining identification information of the device from the device connected to the connector portion;
an identification information deciding unit for deciding the identification information of the peripheral equipment having the device connected thereto, based on the identification information of the peripheral equipment itself stored in the memory and the identification information of the device obtained by the obtaining unit; and
an output unit for supplying the identification information of the peripheral equipment decided by the identification information deciding unit to the computer.

2. The peripheral equipment according to claim 1, wherein,
the device is a device for adding a predetermined function to the peripheral equipment.

3. A printer comprising:
a first memory for storing identification information of the printer itself;
an attaching portion for installing therein a case of accommodating an image-forming medium, having a memory element;
an obtaining unit for obtaining identification information of the case from the memory element of the case attached to the attaching portion;
an identification information deciding unit for deciding the identification information of the printer, based on the identification information of the printer itself and the identification information of the case attached to the attaching portion; and
an output unit for outputting the identification information of the printer decided by the identification information deciding unit.

4. The printer according to claim 3, further comprising:
a second memory for storing the identification information of the case obtained by the obtaining unit, wherein,
upon receipt of the identification information of the case from the memory element of the case attached to the attaching portion, the obtaining unit makes a comparison between the obtained identification information and the identification information stored in the second memory, so as to check whether the case attached to the attaching portion has been exchanged, and
when the case has been exchanged,
the identification information deciding unit decides the identification information of the printer and the output unit outputs the decided identification information of the printer.

5. The printer according to claim 3, wherein,
the identification information deciding unit decides the identification information of the printer by combination of the identification information of the printer itself and the identification information of the case attached to the attaching portion.

6. The printer according to claim 4, wherein,
the identification information deciding unit decides the identification information of the printer by combination of the identification information of the printer itself and the identification information of the case attached to the attaching portion.

7. Peripheral equipment of a computer comprising:
storing means for storing identification information of the peripheral equipment itself;
connecting means for connecting a device;
obtaining means for obtaining identification information of the device from the device connected to the connecting means;
identification information deciding means for deciding the identification information of the peripheral equipment having the device connected thereto, based on the identification information of the peripheral equipment itself stored in the storing means and the identification information of the device obtained by the obtaining means; and
output means for supplying the identification information of the peripheral equipment decided by the identification information deciding means to the computer.

8. A printer comprising:
first storing means for storing identification information of the printer itself;
attaching means for installing therein a case of accommodating an image-forming medium, having a memory element;
obtaining means for obtaining identification information of the case from the memory element of the case attached to the attaching means;
identification information deciding means for deciding the identification information of the printer, based on the identification information of the printer itself and the identification information of the case attached to the attaching means; and
output means for outputting the identification information of the printer decided by the identification information deciding means.

9. A method in which peripheral equipment of a computer creates its own identification information, comprising:
a step of obtaining identification information of a device from the device connected to the peripheral equipment;
a step of reading out the identification information of the peripheral equipment itself from a memory in which the identification information of the peripheral equipment itself is stored;
a step of creating the identification information of the peripheral equipment having the device connected thereto, based on the identification information of the peripheral equipment itself and the obtained identification information of the device; and
a step of supplying the created identification information of the peripheral equipment to the computer.

10. A method in which a printer creates its own identification information, comprising:
a step of reading out the identification information of the printer itself from a first memory in which the identification information of the printer itself is stored;
a step of obtaining identification information of a case from a memory element of the case attached to an attaching portion for installing the case for accommodating an image-forming medium, having the memory element;
a step of deciding the identification information of the printer, based on the identification information of the printer itself and the identification information of the case; and
a step of outputting the decided identification information of the printer.
